(19) United States
(12) Patent Application Publication
(10) Pub. No.: US 2008/0069067 A1
(43) Pub. Date: Mar. 20, 2008

(54) Apparatus, systems, and methods for mobile client secure session parameter updates

(76) Inventors: Kapil Sood, Beaverton, OR (US); Jesse R. Walker, Portland, OR (US); Marc Jalfon, Zichron Yaakov (IL)

Correspondence Address: SCHWEGMAN, LUNDBERG & WOESSNER, P.A., P.O. BOX 2938, MINNEAPOLIS, MN, 55402, US

(21) Appl. No.: 11/522,077

(22) Filed: Sep. 15, 2006

(51) Int. Cl. H04B 7/216

(52) U.S. Cl. 370/342

(57) ABSTRACT

Apparatus, systems, and methods described herein may securely update a set of session parameters in a wireless, packet-switched network without having to disconnect a current session and perform a re-association. Other embodiments may be described and claimed.

### TECHNICAL FIELD

Various embodiments described herein relate to wireless communications generally, including apparatus, systems, and methods associated with session parameter updating.

### BACKGROUND INFORMATION

As wireless networking has evolved, existing core protocols including wireless media access control (MAC) protocols have been adapted to accommodate new features and functions. Quality-of-service (QoS) features, for example, have been integrated into a wireless MAC operating according to an Institute of Electrical and Electronic Engineers (IEEE) 802.11 protocol to prioritize traffic. Additional information regarding the IEEE 802.11 standard may be found in “ANSI/IEEE Std. 802.11, Information technology—Telecommunications and information exchange between systems—Local and metropolitan area networks—Specific requirements—Part 11: Wireless LAN Medium Access Control (MAC) and Physical Layer (PHY) Specifications” (published 1999; reaffirmed June 2003). Some of the new features and functions may require handshaking between wireless devices to determine that each end of a link is capable of supporting the feature or function.

A wireless, packet-switched mobile station (MS) may establish a communications session with a base station (BS) through a process referred to as “association.” During association, the MS and the BS may establish a set of session parameters related to optional or optionable capabilities. As the MS detects changes in the environment, it may be desirable to update the set of session parameters without having to disconnect the current session and perform a time-consuming re-association.

### BRIEF DESCRIPTION OF THE DRAWINGS

FIG. 1 is a diagram of wireless management frames according to various embodiments.

FIG. 2 is a block diagram of an apparatus and a representative system according to various embodiments.

FIG. 3 is a flow diagram according to various embodiments.

FIG. 4 is a block diagram of a computer-readable medium according to various embodiments.

### DETAILED DESCRIPTION

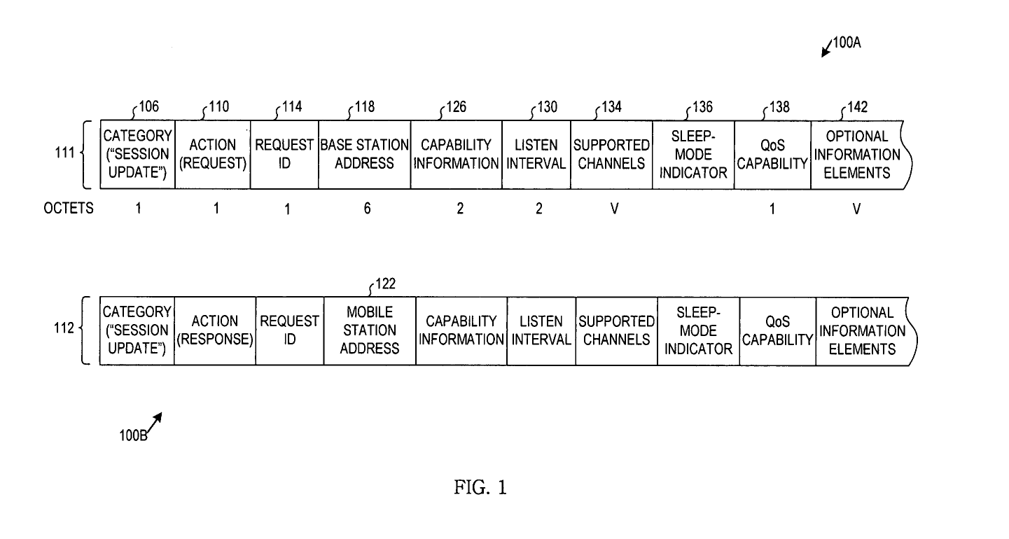

FIG. 1 is a diagram of wireless management frames 100A and 100B according to various embodiments of the invention. Although described in an IEEE 802.11 context, embodiments herein may be applicable to other wireless packet-switched technologies, including but not limited to systems based upon an IEEE 802.16e™ standard, an emerging standard denominated as IEEE 802.21, and others. Additional information regarding the IEEE 802.16e™ protocol standard may be found in 802.16e™: IEEE Standard for Local and Metropolitan Area Networks—Part 16: Air Interface for Fixed and Mobile Broadband Wireless Access Systems—Amendment 2: Physical and Medium Access Control Layers for Combined Fixed and Mobile Operation in Licensed Bands (published Feb. 28, 2006).

The management frames 100A and 100B may be exchanged between an MS and a BS after the MS has securely derived session keys with the BS and has associated with the BS. Some embodiments herein may utilize the management frames 100A and 100B to securely update a set of session parameters without having to disconnect the current session and perform a time-consuming re-association. The management frames 100A and 100B may comprise action-class frames as defined in the IEEE 802.11 standard or an equivalent frame type as may be incorporated in other wireless systems. Under the example 802.11 implementation, the management frames 100A and 100B may be denominated as “session update” category frames and may be so designated in a category field 106.

An action field 110 may identify the management frame 100A as a session update request management packet 111 transmitted from the MS and may identify the management frame 100B as a session update response management packet 112 transmitted from the BS. A request identification field 114 may comprise an identification number used to synchronize requests and associated responses between the MS and the BS. The management frame 100A may include an address field 118 associated with the BS. The management frame 100B may include an address field 122 associated with the MS. The management frames 100A and 100B may also include one or more of a capability information field 126, a listen interval field 130, a supported channels field 134, a sleep-mode indicator field 136, a QoS field 138, and one or more optional information element fields 142 as further described below.

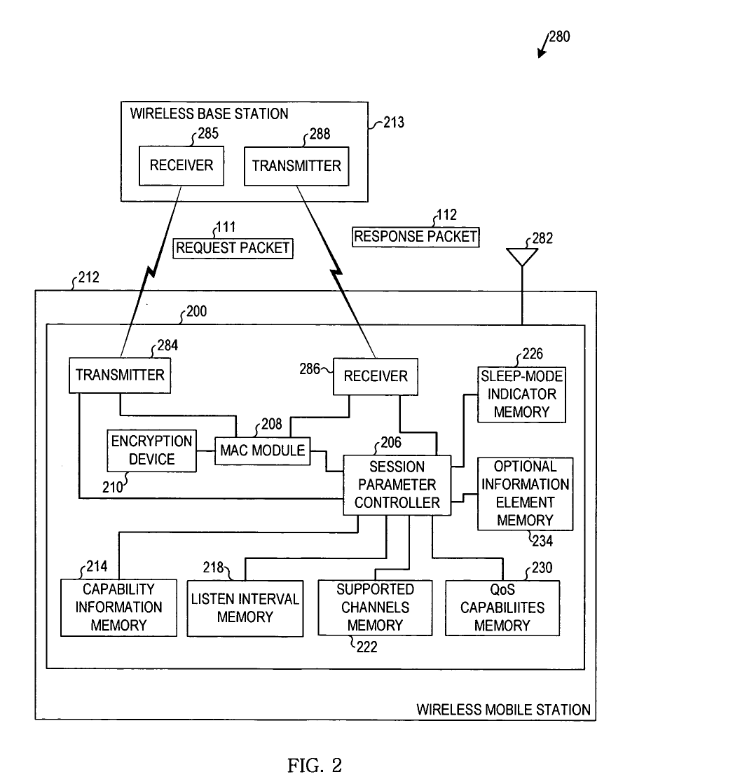

FIG. 2 is a block diagram of an apparatus 200 and a representative system 280 according to various embodiments. The apparatus 200 may include a session parameter controller 206. The session parameter controller 206 may be associated with an MS 212 capable of operating in a wireless, packet-switched network. The session parameter controller 206 may aggregate a set of session parameters for transmission to a BS 213 as a session update request management packet (e.g., the session update request management packet 111 of FIG. 1).

The session parameter controller 206 may also make the set of session parameters current at the MS 212 upon receiving a session update response management packet (e.g., the session update response management packet 112 of FIG. 1) from the BS 213. An update operation, including exchanging the session update request management packet 111 and the session update response management packet 112 and making the set of session parameters current at the MS 212, may be performed while maintaining a single, continuous, secure wireless association between the MS 212 and the BS 213.

The apparatus 200 may also include a MAC module 208 coupled to the session parameter controller 206. The MAC module 208 may format the session update request management packet 111 to include the set of session parameters. An encryption device 210 may be operatively coupled to the session parameter controller 206 and/or to the MAC module 208. The encryption device 210 may encrypt the session update request management packet 111 and may decrypt the session update response management packet 112. The set of requested session parameters may thus be securely updated while maintaining the single, continuous, secure wireless association between the MS 212 and the BS 213.

The apparatus 200 may further include a capability information memory 214 coupled to the session parameter controller 206. The capability information memory 214 may provide a set of parameters associated with optional device capabilities to the session parameter controller 206. The optional device capabilities may comprise a contention-free mode of operation, a variable preamble length, a variable coding type, variable channel and spectrum management schemes, a quality-of-service mode of operation, a power saving mode of operation, and operation according to a specified modulation scheme, among others.

A listen interval memory 218 may also be coupled to the session parameter controller 206. The listen interval memory 218 may provide an indication to the session parameter controller 206 of a periodicity with which the MS 212 may awaken to listen to beacon management frames received from the BS 213.

The apparatus 200 may also include a supported channels memory 222 coupled to the session parameter controller 206. The supported channels memory 222 may provide a supported channels element to the session parameter controller 206. The supported channels element may identify a set of channels associated with each of a set of sub-bands supported by the MS 212.

A sleep-mode indicator memory 226 may also be coupled to the session parameter controller 206. The sleep-mode indicator memory 226 may provide a sleep-mode indication to the session parameter controller 206 to indicate whether a sending entity is entering a power-saving mode of operation.

The apparatus 200 may further include a QoS capabilities memory 230 coupled to the session parameter controller 206. The QoS capabilities memory 230 may provide a set of QoS capabilities to the session parameter controller 206. The set of QoS capabilities may include one or more flags to identify a mode used by the MS 212 to request packets buffered at the BS 213 while the MS 212 is in the sleep mode.

An optional information element memory 234 may also be coupled to the session parameter controller 206. The optional information element memory 234 may provide one or more optional information elements to the session parameter controller 206 for secure transmission to the BS. The optional information elements may be defined according to an IEEE 802.11 standard or an IEEE 802.16 standard, among others.

Structural elements associated with the apparatus 200 are described above and depicted in FIG. 2 in exemplary embodiments at the MS 212. As those skilled in the art can readily appreciate, similar structural embodiments (not shown in FIG. 2) may be associated with the BS 213. The MS 212-based structures and the BS 213-based structures may interoperate to produce the useful results described herein. Such results may include securely updating a set of session parameters related to an in-process wireless association and making the updated set of session parameters current at both the MS 212 and the BS 213 without having to re-establish the wireless association.

In another embodiment, a system 280 may include one or more of the apparatus 200, as previously described. The system 280 may also include an antenna 282 coupled to the session parameter controller 206. The antenna 282 may comprise a patch, omnidirectional, beam, monopole, dipole, or slot antenna, among other types. The antenna 282 may propagate a transmission from the MS 212 to the BS 213.

The system 280 may also include a transmitter 284 operatively coupled to the session parameter controller 206. The transmitter 284 may transmit the session update management request packet 111 from the MS 212 to a receiver 285 located at the BS 213. Similarly, a receiver 286 may be operatively coupled to the session parameter controller 206 to receive the session update response management packet 112 from a transmitter 288 associated with the BS 213.

Any of the components previously described may be implemented in a number of ways, including embodiments in software. Thus, the management frames 100A and 100B; the fields 106, 110, 114, 118, 122, 126, 130, 134, 136, 138, 142; the packets 111, 112; the apparatus 200; the session parameter controller 206; the MS 212; the BS 213; the MAC module 208; the encryption device 210; the memories 214, 218, 222, 226, 230, 234; the system 280; the antenna 282; the transmitters 284, 288; and the receivers 285, 286 may all be characterized as “modules” herein.

The modules may include hardware circuitry, single or multi-processor circuits, memory circuits, software program modules and objects, firmware, and combinations thereof as desired by the architect of the apparatus 200 and the system 280 and as appropriate for particular implementations of various embodiments.

The various embodiments disclosed herein may be useful in applications other than securely updating a set of session parameters in a wireless, packet-switched network without having to disconnect the current session and perform a re-association. Re-association may be resource intensive and time consuming when performed securely in an authenticated environment. Thus, various embodiments of the invention are not to be so limited. The illustrations of the apparatus 200 and the system 280 are intended to provide a general understanding of the structure of various embodiments. They are not intended to serve as a complete description of all the elements and features of apparatus and systems that might make use of the structures described herein.

The apparatus and systems of various embodiments may be included in electronic circuitry used in high-speed computers, communication and signal processing circuitry, modems, single or multi-processor modules, single or multiple embedded processors, multi-core processors, data switches, and application-specific modules, including multilayer, multi-chip modules. Such apparatus and systems may also be included as sub-components within a variety of electronic systems such as televisions, cellular telephones, personal computers (e.g., laptop computers, desktop computers, handheld computers, tablet computers, etc.), workstations, radios, video players, audio players (e.g., Motion Picture Experts Group, Audio Layer 3 (MP3) players), vehicles, medical devices (e.g., heart monitor, blood pressure monitor, etc.), set top boxes, and others. Some embodiments may include a number of methods.

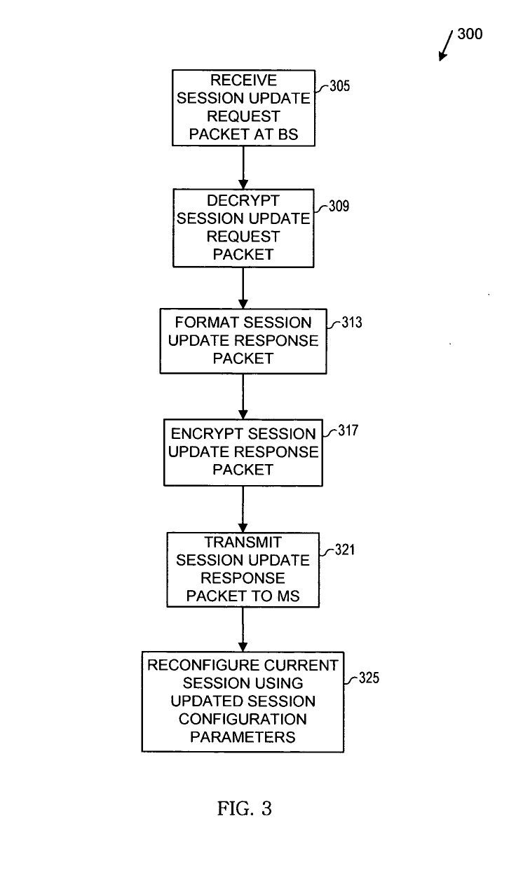

FIG. 3 is a flow diagram illustrating several methods according to various embodiments. A method 300 may commence at block 305 with receiving an encrypted session update request management packet at a BS from an MS. The MS may be in a wireless association with the BS in a packet-switched network. The encrypted session update request management packet may contain a first set of session configuration parameters. The method 300 may continue at block 309 with decrypting the encrypted session update request management packet.

The method 300 may also include formatting a session update response management packet with a second set of session configuration parameters for transmission to the MS, at block 313. The second set of session configuration parameters may include a category identifier, an action field, a request identifier, and an MS address. The second set of session configuration parameters may also include a set of capability information parameters, a listen interval parameter, parameters to identify a set of supported channels, a sleep-mode indicator, a set of quality-of-service parameters, and one or more optional information elements. Other session parameters that may benefit from intra-session updating may be added to the aforementioned list of examples. The session update response management packet may advise the MS that the BS will reconfigured the current session according to the second set of session configuration parameters.

The method 300 may further include encrypting the session update response management packet, at block 317. An existing session key may be used to decrypt the encrypted session update request management packet and to encrypt the session update response management packet. That is, the secure session update packets may be transferred back and forth without having to derive a new session key.

Some embodiments herein may decrypt the encrypted session update request management packet and encrypt the session update response management packet utilizing an encryption protocol operating according to an IEEE 802.11i standard. Additional information regarding the IEEE 802.11i standard may be found in “IEEE 802.11i™ Standard for Information technology—Telecommunications and information exchange between systems—Local and metropolitan area networks—Specific requirements Part 11: Wireless LAN Medium Access Control (MAC) and Physical Layer (PHY) specifications Amendment 6: Medium Access Control (MAC) Security Enhancements” (July 2004). Some embodiments may utilize a temporal key component of a session key in the encryption and decryption operations. Other encryption techniques and standards may also be used.

The method 300 may continue at block 321 with transmitting the session update response management packet to the MS from the BS. The method 300 may terminate at block 325 with reconfiguring the current session with the MS using the second set of session configuration parameters while maintaining the wireless association with the MS. Reconfiguring the current session may include making the second set of session configuration parameters current at both the MS and the BS, as previously described.

It may be possible to execute the activities described herein in an order other than the order described. Further, various activities described with respect to the methods identified herein may be executed in repetitive, serial, or parallel fashion.

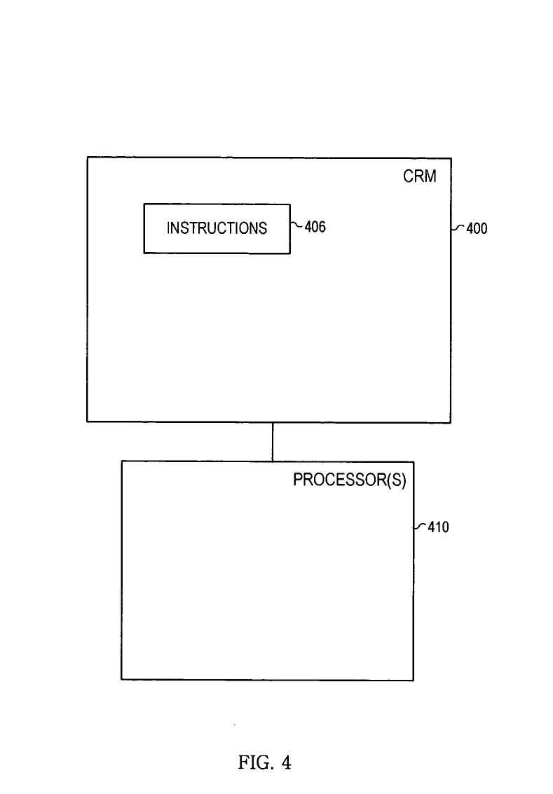

A software program may be launched from a computer-readable medium (CRM) in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment. Thus, other embodiments may be realized, as discussed regarding FIG. 4 below.

FIG. 4 is a block diagram of a CRM 400 according to various embodiments of the invention. Examples of such embodiments may comprise a memory system, a magnetic or optical disk, or some other storage device. The CRM 400 may contain instructions 406 which, when accessed, result in one or more processors 410 performing any of the activities previously described, including those discussed with respect to the method 300 noted above.

Implementing the apparatus, systems, and methods disclosed herein may operate to securely update a set of session parameters in a wireless, packet-switched network without having to disconnect the current session and perform a time-consuming re-association.

Although the inventive concept may include embodiments described in the exemplary context of an Institute of Electrical and Electronic Engineers (IEEE) standard 802.xx implementation (e.g., 802.11, 802.11a, 802.11b, 802.11e, 802.11g, 802.16, 802.16e™, etc.), the claims are not so limited. Additional information regarding the IEEE 802.11a protocol standard may be found in “IEEE Std 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band” (published 1999; reaffirmed Jun. 12, 2003). Additional information regarding the IEEE 802.11b protocol standard may be found in “IEEE Std 802.11b, Supplement to IEEE Standard for Information technology—Telecommunications and information exchange between systems—Local and metropolitan area networks—Specific requirements—Part 11: Wireless LAN Medium Access Control (MAC) and Physical Layer (PHY) specifications: Higher-Speed Physical Layer Extension in the 2.4 GHz Band” (approved Sep. 16, 1999; reaffirmed Jun. 12, 2003). Additional information regarding the IEEE 802.11e standard may be found in “IEEE 802.11e Standard for Information technology—Telecommunications and information exchange between systems—Local and metropolitan area networks—Specific requirements Part 11: Wireless LAN Medium Access Control (MAC) and Physical Layer (PHY) specifications: Amendment 8: Medium Access Control (MAC) Quality of Service Enhancements” (published 2005). Additional information regarding the IEEE 802.11g protocol standard may be found in “IEEE Std 802.11g™, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band” (approved Jun. 12, 2003). Additional information regarding the IEEE 802.16 protocol standard may be found in “IEEE Standard for Local and Metropolitan Area Networks—Part 16: Air Interface for Fixed Broadband Wireless Access Systems” (published Oct. 1, 2004).

Embodiments of the present invention may be implemented as part of a wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan area network (WMAN), a wireless wide area network (WWAN), a cellular network, a third generation (3G) network, a fourth generation (4G) network, a universal mobile telephone system (UMTS), and like communication systems without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense; and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of the embodiments described herein. Combinations of these embodiments and other embodiments not specifically described herein will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a session parameter controller in a mobile station (MS) capable of operating in a wireless, packet-switched network, the session parameter controller to aggregate a set of session parameters for transmission to a base station (BS) as a session update request management packet and to make the set of session parameters current at the MS upon receiving a session update response management packet from the BS while maintaining a single, continuous, secure wireless association with the BS; and
an encryption device operatively coupled to the session parameter controller to encrypt the session update request management packet and to decrypt the session update response management packet to securely update the set of session parameters while maintaining the single, continuous secure wireless association with the BS.

2. The apparatus of claim 1, wherein the wireless, packet-switched network is configured to operate according to at least one of an Institute of Electrical and Electronic Engineers (IEEE) 802.11 standard or an IEEE 802.16 standard.

3. The apparatus of claim 1, further including:
a media access control module coupled to the session parameter controller to format the session update request management packet to include the set of session parameters.

4. The apparatus of claim 1, further including:
a capability information memory coupled to the session parameter controller to provide a set of parameters associated with optional device capabilities to the session parameter controller.

5. The apparatus of claim 4, wherein the optional device capabilities comprise at least one of a contention-free mode of operation, a variable preamble length, a variable coding type, variable channel and spectrum management schemes, a quality-of-service mode of operation, a power saving mode of operation, or operation according to a specified modulation scheme.

6. The apparatus of claim 1, further including:
a listen interval memory coupled to the session parameter controller to provide an indication to the session parameter controller of a periodicity with which the MS awakens to listen to beacon management frames received from the BS.

7. The apparatus of claim 1 further including:
a supported channels memory coupled to the session parameter controller to provide a supported channels element to the session parameter controller, the supported channels element to identify a set of channels associated with each of a set of sub-bands supported by the MS.

8. The apparatus of claim 1, further including:
a sleep-mode indicator memory coupled to the session parameter controller to provide a sleep-mode indication to the session parameter controller to indicate whether a sending entity is entering a power-saving mode of operation.

9. The apparatus of claim 1, further including:
a quality-of-service (QoS) capabilities memory coupled to the session parameter controller to provide a set of QoS capabilities to the session parameter controller.

10. The apparatus of claim 9, wherein the set of QoS capabilities includes at least one flag to identify a mode used by the MS to request packets buffered at the BS while the MS is in a sleep mode.

11. The apparatus of claim 1, further including:
an optional information element memory coupled to the session parameter controller to provide at least one optional information element to the session parameter controller for secure transmission to the BS.

12. The apparatus of claim 11, wherein the at least one optional information element is defined according to at least one of an Institute of Electrical and Electronic Engineers (IEEE) 802.11 standard or an IEEE 802.16 standard.

13. A system, including:
a session parameter controller at a mobile station (MS) capable of operating in a wireless, packet-switched network, the session parameter controller to aggregate a set of session parameters for transmission to a base station (BS) as a session update request management packet and to make the set of session parameters current at the MS upon receiving a session update response management packet from the BS while maintaining a single, continuous, secure wireless association with the BS;
an encryption device operatively coupled to the session parameter controller to encrypt the session update request management packet and to decrypt the session update response management packet to securely update the set of session parameters while maintaining the single, continuous, secure wireless association with the BS; and
an omnidirectional antenna operatively coupled to the session parameter controller to propagate a transmission from the MS to the BS.

14. The system of claim 13, further including:
a transmitter operatively coupled to the session parameter controller to transmit the session update management request packet to the BS.

15. The system of claim 13, further including:
a receiver operatively coupled to the session parameter controller to receive the session update response management packet from the BS.

16. A method, including:
at a base station (BS) in a wireless packet-switched network, receiving an encrypted session update request management packet from a mobile station (MS), wherein the MS is in a wireless association with the BS, and wherein the encrypted session update request management packet contains a first set of session configuration parameters; and
reconfiguring a current session with the MS using a second set of session configuration parameters while maintaining the wireless association with the MS.

17. The method of claim 16, further including:
at the BS, transmitting a session update response management packet to the MS, wherein the session update response management packet operates to advise the MS that the BS will reconfigure the current session according to a second set of session configuration parameters included in the session update response management packet.

18. The method of claim 17, further including:
at the BS, decrypting the encrypted session update request management packet; and
encrypting the session update response management packet.

19. The method of claim 18, further including:
utilizing an existing session key to decrypt the encrypted session update request management packet and to encrypt the session update response management packet.

20. The method of claim 18, further including:
utilizing an encryption protocol according to an Institute of Electrical and Electronic Engineers (IEEE) 802.11i standard to decrypt the encrypted session update request management packet and to encrypt the session update response management packet.

21. The method of claim 17, further including:
formatting the session update response management packet with the second set of session configuration parameters, wherein the second set of session configuration parameters includes a category identifier, an action field, a request identifier, and an MS address.

22. The method of claim 21, wherein the second set of session configuration parameters further includes at least one of a set of capability information parameters, a listen interval parameter, parameters to identify a set of supported channels, a sleep-mode indicator, a set of quality-of-service parameters, or at least one optional information element.

23. A computer-readable medium having instructions, wherein the instructions, when executed, result in at least one processor performing:
at a base station (BS) in a wireless packet-switched network, receiving an encrypted session update request management packet from a mobile station (MS), wherein the MS is in a wireless association with the BS, and wherein the encrypted session update request management packet contains a first set of session configuration parameters; and
reconfiguring a current session with the MS using the first set of session configuration parameters while maintaining the wireless association with the MS.

24. The computer-readable medium of claim 23, wherein the instructions, when executed, result in the at least one processor performing:
at the BS, decrypting the encrypted session update request management packet utilizing a temporal key component of a session key according to an Institute of Electrical and Electronic Engineers (IEEE) 802.11i standard.

25. The computer-readable medium of claim 23, wherein the instructions, when executed, result in the at least one processor performing:
at the BS, configuring a session update response management packet to include at least one of a category identifier, an action field a request identifier, an MS address, a set of capability information parameters, a listen interval parameter, parameters to identify a set of supported channels, a sleep-mode indicator, a set of quality-of-service parameters, or at least one optional information element; and
transmitting the session update response management packet to the MS.
